(19) United States
(12) Patent Application Publication
(10) Pub. No.: US 2021/0321635 A1
(43) Pub. Date: Oct. 21, 2021

(54) CHEESE-LIKE FOOD

(71) Applicant: J-OIL MILLS, INC., Tokyo (JP)

(72) Inventors: Shunsuke SAKURAI, Tokyo (JP); Hirofumi NOGAMI, Tokyo (JP); Minako HIRAOKA, Tokyo (JP); Tadayoshi SADAKANE, Tokyo (JP); Miyuki MATSUSHIMA, Tokyo (JP)

(21) Appl. No.: 17/269,339

(22) PCT Filed: Aug. 21, 2019
(86) PCT No.: PCT/JP2019/032531

§ 371 Date: Feb. 18, 2021

(30) Foreign Application Priority Data
Aug. 31, 2018 (JP) 2018-162228

(51) Int. Cl. A23C 20/02; A21D 13/28

(52) U.S. Cl. CPC A23C 20/02; A21D 13/28

(57) ABSTRACT

The present invention pertains to: a cheese-like food, preferably a cheese-like food having a texture inherent to cheese and a high heat meltability; a method for manufacturing a cheese-like food; and a method for improving the heat meltability of a cheese-like food. The cheese-like food according to the present invention, which comprises 2-30 mass % inclusive of an acetylated oxidized starch, 10-35 mass % inclusive of an edible fat or oil, and 30-65 mass % inclusive of water, is characterized in that the solid fat content at 10° C. of the edible fat or oil is 20-95% inclusive.

### FIELD

The present invention relates to a cheese-like food.

### BACKGROUND

Cheese is a kind of food (dairy product) produced by using milk from cows, water buffaloes, sheep, goats, yaks or the like as a raw material and carrying out processing such as coagulation and fermentation. Cheese is not only eaten directly but also often used in combination with another food. For example, cheese is used for various dishes including pizza, pasta, gratin, risotto and cheese fondue, and the demand for cheese has been increasing year by year.

Meanwhile, with the decrease in the number of livestock farmers, the amount of production of milk for processing to be used for cheese has been decreasing year by year. For this reason, it is difficult to supply cheese in an amount that meets the demand. Under such circumstances, it has been desired to develop a cheese-like food which can be used like cheese.

As a cheese-like food, a formed cheese-like food containing an acid-treated starch is disclosed, see Japanese Laid-Open Patent Publication No. 2015-065948. The formed cheese-like food is regarded as having suitability for forming and heat-resistant shape retention. Further, a heat-resistant cheese-like processed food containing an oxidized starch is disclosed, see Japanese Patent No. 6222788. The heat-resistant cheese-like processed food is regarded as having heat-resistant shape retention.

### SUMMARY

The difficulties and drawbacks associated with previous approaches are addressed in the present subject matter as follows.

In one aspect, the present invention provides a cheese-like food comprising 2 to 30% by mass of an acetylated oxidized starch, 10 to 35% by mass of an edible fat or oil and 30 to 65% by mass of water, wherein the solid fat content in the edible fat or oil at 10° C. is 20 to 95%.

In another aspect, the present invention provides a method for producing a cheese-like food. The method comprises preparing a mixture comprising water, an acetylated oxidized starch and an edible fat or oil; heating and stirring the mixture to obtain an emulsified liquid; and cooling the emulsified liquid, wherein the cheese-like food comprises 2 to 30% by mass of the acetylated oxidized starch, 10 to 35% by mass of the edible fat or oil and 30 to 65% by mass of water, and wherein the solid fat content in the edible fat or oil at 10° C. is 20 to 95%.

In still another aspect, the present method for improving the heat meltability of a cheese-like food comprising an edible fat or oil and water, utilizes a cheese-like food that comprises 2 to 30% by mass of an acetylated oxidized starch.

As will be realized, the subject matter described herein is capable of other and different embodiments and its several details are capable of modifications in various respects, all without departing from the claimed subject matter. Accordingly, the drawings and description are to be regarded as illustrative and not restrictive.

### DETAILED DESCRIPTION OF THE EMBODIMENTS

Cheese-like foods are required to have various physical properties depending on cooking applications, etc. The objective of the present invention is to provide a novel cheese-like food. According to a preferred embodiment of the present invention, it is possible to provide a cheese-like food having a texture inherent to cheese and a high heat meltability.

The present inventors provide a cheese-like food comprising specific amounts of a specific starch, a specific edible fat or oil and water. According to a preferred embodiment of the present invention, the cheese-like food of the present invention has a texture inherent to cheese and a high heat meltability.

Specifically, the present invention is a cheese-like food comprising 2 to 30% by mass of an acetylated oxidized starch, 10 to 35% by mass of an edible fat or oil and 30 to 65% by mass of water, wherein the solid fat content in the edible fat or oil at 10° C. is 20 to 95%. In one embodiment of the present invention, the solid fat content in the edible fat or oil at 10° C. is preferably 20 to 75%.

The cheese-like food preferably comprises 1 to 19% by mass of an acid-treated starch.

The content of the acetylated oxidized starch is preferably 8 to 250 parts by mass relative to 100 parts by mass of the content of the edible fat or oil.

The solid fat content in the edible fat or oil at 35° C. is preferably 0 to 10%.

The cheese-like food is preferably heated.

Further, the present invention is a food comprising the cheese-like food.

Further, the present invention is a method for producing a cheese-like food, the method comprising: preparing a mixture comprising water, an acetylated oxidized starch and an edible fat or oil; heating and stirring the mixture to obtain an emulsified liquid; and cooling the emulsified liquid, wherein the cheese-like food comprises 2 to 30% by mass of the acetylated oxidized starch, 10 to 35% by mass of the edible fat or oil and 30 to 65% by mass of water, and wherein the solid fat content in the edible fat or oil at 10° C. is 20 to 95%. In one embodiment of the present invention, the solid fat content in the edible fat or oil at 10° C. is preferably 20 to 75%.

Further, the present invention is a method for improving the heat meltability of a cheese-like food comprising an edible fat or oil and water, which includes 2 to 30% by mass of an acetylated oxidized starch being contained in the cheese-like food.

The cheese-like food preferably comprises 10 to 35% by mass of the edible fat or oil and 30 to 65% by mass of water.

The solid fat content in the edible fat or oil at 10° C. is preferably 20 to 95%. In one embodiment of the present invention, the solid fat content in the edible fat or oil at 10° C. is preferably 20 to 75%.

According to the present invention, it is possible to provide a novel cheese-like food. According to a preferred embodiment of the present invention, it is possible to provide a cheese-like food having a texture inherent to cheese and a high heat meltability.

The cheese-like food of the present invention means a food similar to processed cheese prepared by combined use of a starch, an edible fat or oil, etc., which is different from natural cheese and processed cheese defined in the Ministerial Ordinance Concerning Compositional Standards, etc. for Milk and Milk Products (Ministry of Health and Welfare Ordinance of Japan No. 52 of 1951).

The cheese-like food of the present invention comprises 2 to 30% by mass of an acetylated oxidized starch, 10 to 35% by mass of an edible fat or oil and 30 to 65% by mass of water, wherein the solid fat content in the edible fat or oil at 10° C. is 20 to 95%.

The acetylated oxidized starch contained in the cheese-like food of the present invention is a starch obtained by subjecting a raw material starch to acetylation treatment and oxidation treatment. The raw material starch is not particularly limited, but is preferably a tapioca starch. Further, the acetylated oxidized starch may be a starch which has been subjected to another processing treatment such as crosslinking treatment, etherification treatment and enzyme treatment as long as it has been subjected to acetylation treatment and oxidation treatment, but it is preferably a starch obtained by being subjected only to acetylation treatment and oxidation treatment.

The content of the acetylated oxidized starch contained in the cheese-like food of the present invention is 2 to 30% by mass, preferably 4 to 30% by mass, more preferably 10 to 30% by mass, even more preferably 15 to 30% by mass, still more preferably 15 to 25% by mass, and still even more preferably 15 to 24% by mass. When the content is within the above-described range, it is possible to provide a cheese-like food having a high heat meltability.

The cheese-like food of the present invention preferably comprises an acid-treated starch. The acid-treated starch is preferably an acid-treated corn starch, and more preferably an acid-treated waxy corn starch. The content of the acid-treated starch contained in the cheese-like food is preferably 1 to 19% by mass, more preferably 1 to 16% by mass, even more preferably 1 to 15% by mass, still more preferably 2 to 14% by mass, still even more preferably 3 to 10% by mass, and particularly preferably 3 to 8% by mass. When the content is within the above-described range, the heat meltability of the cheese-like food can be improved.

The content of the acid-treated starch relative to 100 parts by mass of the content of the acetylated oxidized starch in the cheese-like food of the present invention is preferably 10 to 500 parts by mass, more preferably 10 to 400 parts by mass, even more preferably 10 to 200 parts by mass, still more preferably 10 to 100 parts by mass, still even more preferably 10 to 70 parts by mass, and particularly preferably 15 to 50 parts by mass. When the content is within the above-described range, it is possible to provide a cheese-like food having a high heat meltability and an excellent texture after heating.

Examples of a raw fat or oil to be used for the edible fat or oil contained in the cheese-like food of the present invention include: vegetable fats and oils such as soybean oil, rapeseed oil, corn oil, cottonseed oil, rice bran oil, sunflower oil, safflower oil, sesame oil, olive oil, palm oil, palm kernel oil and coconut oil; animal fats and oils such as fish oil, lard, beef tallow and milk fat; medium-chain triglyceride, and processed fats and oils obtained by subjecting the aforementioned materials to one or more processing treatments selected from the group consisting of transesterification, hydrogenation and separation.

The edible fat or oil preferably comprises one or more selected from the group consisting of vegetable fats and oils and processed fats and oils thereof, more preferably comprises one or more selected from the group consisting of soybean oil, rapeseed oil, corn oil, cottonseed oil, rice bran oil, sunflower oil, safflower oil, sesame oil, olive oil, palm oil, palm kernel oil, coconut oil and processed fats and oils thereof, even more preferably comprises one or more selected from the group consisting of rapeseed oil, palm oil, palm kernel oil, coconut oil and processed fats and oils thereof, still more preferably comprises one or more selected from the group consisting of rapeseed oil, palm oil, palm kernel oil and coconut oil, and particularly preferably comprises palm oil.

Further, the edible fat or oil preferably contains 30 to 100% by mass of one or more selected from the group consisting of palm oil, palm kernel oil, coconut oil and processed fats and oils thereof, more preferably contains 30 to 100% by mass of one or more selected from the group consisting of palm oil, palm kernel oil and coconut oil, even more preferably contains 50 to 100% by mass of one or more selected from the group consisting of palm oil, palm kernel oil and coconut oil, and still more preferably contains 70 to 100% by mass of one or more selected from the group consisting of palm oil, palm kernel oil and coconut oil.

The solid fat content in the edible fat or oil at 10° C. is 20 to 95%, preferably 23 to 90%, more preferably 25 to 85%, and even more preferably 30 to 70%. Further, in one embodiment of the present invention, the solid fat content in the edible fat or oil at 10° C. is preferably 20 to 75%, and more preferably 25 to 70%. When it is within the above-described range, a texture inherent to cheese can be imparted to the cheese-like food.

Further, the solid fat content in the edible fat or oil at 35° C. is preferably 0 to 10%, more preferably 0 to 8%, and even more preferably 3 to 8%. When it is within the above-described range, it is possible to provide a cheese-like food having a high heat meltability.

Moreover, the solid fat content in the edible fat or oil at 20° C. is preferably 5 to 50%, more preferably 7 to 40%, even more preferably 9 to 40%, still more preferably 10 to 40%, and still even more preferably 20 to 30%.

The solid fat content in the edible fat or oil can be measured according to METHOD I described in AOCS Official Method Cd 16b-93.

The slip melting point of the edible fat or oil is preferably 20 to 40° C., and more preferably 22 to 35° C. The slip melting point of the edible fat or oil can be measured according to 2.2.4.2 Melting Point (Slip Melting Point) in the Standard Methods for the Analysis of Fats, Oils and Related Materials (1996).

The content of the edible fat or oil in the cheese-like food of the present invention is 10% by mass or more, preferably 13% by mass or more, and more preferably 18% by mass or more. Further, the content of the edible fat or oil in the cheese-like food of the present invention is 35% by mass or less, preferably 32% by mass or less, and more preferably 30% by mass or less. The content of the edible fat or oil in the cheese-like food of the present invention is 10 to 35% by mass. Further, these upper limits and lower limits may be suitably combined. For example, the content of the edible fat or oil in the cheese-like food of the present invention is preferably 13 to 32% by mass, and more preferably 18 to 30% by mass. When it is within the above-described range, it is possible to provide a cheese-like food having a texture inherent to cheese and a high heat meltability.

The content of the acetylated oxidized starch relative to 100 parts by mass of the edible fat or oil in the cheese-like food of the present invention is preferably 8 parts by mass or more, more preferably 20 parts by mass or more, even more preferably 50 parts by mass or more, and still more preferably 80 parts by mass or more. Further, the content of the acetylated oxidized starch relative to 100 parts by mass of the edible fat or oil in the cheese-like food of the present invention is preferably 250 parts by mass or less, and more preferably 200 parts by mass or less. These upper limits and lower limits may be suitably combined. For example, the content of the acetylated oxidized starch relative to 100 parts by mass of the edible fat or oil in the cheese-like food of the present invention is preferably 8 to 250 parts by mass, more preferably 20 to 200 parts by mass, even more preferably 50 to 200 parts by mass, and still more preferably 80 to 200 parts by mass. When it is within the above-described range, it is possible to provide a cheese-like food having a high heat meltability.

The content of water in the cheese-like food of the present invention is 30% by mass or more, preferably 35% by mass or more, more preferably 40% by mass or more, even more preferably 45% by mass or more, and still more preferably 48% by mass or more. Further, the content of water in the cheese-like food of the present invention is 65% by mass or less, preferably 60% by mass or less, and more preferably 58% by mass or less. The content of water in the cheese-like food of the present invention is 30 to 65% by mass. Further, these upper limits and lower limits may be suitably combined. For example, the content of water in the cheese-like food of the present invention is preferably 35 to 60% by mass, more preferably 40 to 58% by mass, even more preferably 45 to 58% by mass, and still more preferably 48 to 58% by mass. Note that the water contained in the cheese-like food of the present invention may be contained in the form of a water-containing liquid such as a vegetable emulsified liquid such as soy milk, almond milk, rice milk and coconut milk; an animal emulsified liquid such as raw milk, low-fat milk and fat-free milk; a vegetable juice; and a fruit juice.

The cheese-like food of the present invention may contain a material having an emulsifying function. Examples of the material having the emulsifying function include an emulsifier such as lecithin, monoglycerol fatty acid ester, organic acid mono-fatty acid glyceride, polyglycerol fatty acid ester, polyglycerol condensed ricinoleic acid ester, propylene glycol fatty acid ester, sorbitan fatty acid ester, sucrose fatty acid ester and polyoxyethylene sorbitan fatty acid ester; and starch sodium octenyl succinate. The cheese-like food preferably contains starch sodium octenyl succinate, and more preferably contains 1 to 5% by mass of starch sodium octenyl succinate in the cheese-like food.

The cheese-like food of the present invention can contain a component other than the acetylated oxidized starch, the acid-treated starch, the edible fat or oil, the water and the material having the emulsifying function without particular limitation within a range in which the effects of the present invention are not reduced. Examples of the component include: an antioxidant such as L-ascorbic acid, L-ascorbic acid derivative, tocopherol, tocotrienol, lignan, ubiquinones, xanthines, oryzanol, plant sterol, catechins, polyphenols and tea extract; a coloring such as carotene; a flavoring; silicone; a seasoning such as salt, sugar and amino acids; polysaccharides such as a starch other than the acetylated oxidized starch, the acid-treated starch and starch sodium octenyl succinate, xanthan gum, guar gum, gum Arabic, pectin, locust bean gum, alginic acid, dextrin and cellulose; a milk constituent such as casein sodium and skimmed milk powder; and cheeses such as natural cheese and processed cheese.

The total content of the acetylated oxidized starch, the edible fat or oil and the water in the cheese-like food of the present invention is preferably 55 to 100% by mass, more preferably 65 to 100% by mass, even more preferably 75 to 100% by mass, and still more preferably 85 to 100% by mass.

Further, the total content of the acetylated oxidized starch, the acid-treated starch, the edible fat or oil, the water and the material having the emulsifying function in the cheese-like food of the present invention is preferably 60 to 100% by mass, more preferably 70 to 100% by mass, even more preferably 80 to 100% by mass, and still more preferably 90 to 100% by mass.

According to a preferred embodiment of the present invention, the cheese-like food of the present invention can be used as a food combined with another ingredient and is suitable as a topping or filling for foods to be cooked with heat. Specific examples of such foods include toast, pizza, gratin, rice casserole, lasagna, hamburg steak and risotto. According to a preferred embodiment of the present invention, the cheese-like food of the present invention has a high heat meltability, and when it is used as a topping or filling for foods to be cooked with heat, a cheese-like texture and a viscosity inherent to cheese are obtained by heating. For this reason, the cheese-like food is useful as a replacement for cheese to be cooked with heat. According to a preferred embodiment of the present invention, it is possible to provide a cheese-like food having a cheese-like texture and heat meltability without using a component derived from milk or with the amount of the component used being reduced.

The method for producing a cheese-like food of the present invention comprises: a step of preparing a mixture comprising water, an acetylated oxidized starch and an edible fat or oil; a step of heating and stirring the mixture to obtain an emulsified liquid; and a step of cooling the emulsified liquid. The cheese-like food produced comprises 2 to 30% by mass of the acetylated oxidized starch, 10 to 35% by mass of the edible fat or oil and 30 to 65% by mass of water, and the solid fat content in the edible fat or oil at 10° C. is 20 to 95%. In one embodiment of the present invention, the solid fat content in the edible fat or oil at 10° C. is preferably 20 to 75%. A preferred embodiment of the cheese-like food produced is the same as that explained with respect to the cheese-like food of the present invention.

In the step of preparing the mixture, water, the acetylated oxidized starch and the edible fat or oil may be mixed at the same time, or any two of them may be mixed in advance, followed by adding the remaining component to be mixed, but the step preferably includes a step of preparing a mixture comprising water and the acetylated oxidized starch and a step of mixing the mixture with the edible fat or oil. The content of the acetylated oxidized starch contained in the mixture is preferably 5 to 70 parts by mass relative to 100 parts by mass of water contained in the mixture. Further, the step of preparing the mixture preferably includes a step of heating the mixture to 60° C. or higher but lower than 100° C. When the step of heating is included, the mixture becomes a liquid glue, and a more cheese-like texture can be imparted to the cheese-like food. In addition, the mixture preferably comprises an acid-treated starch. Regarding other optional components including the material having the emulsifying function, a water-soluble optional component may be mixed with the mixture in advance and an oil-soluble optional component may be mixed with the edible fat or oil in advance, and alternatively, these optional components may be added and mixed later in the step of mixing the mixture with the edible fat or oil.

In the step of mixing the mixture with the edible fat or oil, the mixture is preferably mixed in an amount of 200 to 700 parts by mass relative to 100 parts by mass of the edible fat or oil. Further, the edible fat or oil to be mixed with the mixture is preferably in the state of a liquid heated at 60° C. or higher but lower than 100° C. Moreover, the step of mixing is preferably in the state of being heated to 60° C. or higher but lower than 100° C.

In the step of heating and stirring the mixture to obtain the emulsified liquid, the heating temperature is preferably 60° C. or higher but lower than 100° C. Further, as the stirring method, any method may be employed as long as the mixture becomes the emulsified liquid. For example, a method using a propeller-type stirrer, a cutter mixer, a homomixer, a cooker-type emulsifying machine, a kettle-type emulsifying machine, a Stephan mixer, a spread surface heat exchanger or the like may be employed.

In the step of cooling the emulsified liquid, the cooling temperature is preferably a temperature at which the temperature of the emulsified liquid becomes higher than 0° C. and 10° C. or lower. When the cooling temperature is set as described above, a cheese-like hardness can be imparted to the emulsified liquid. Further, the step of cooling may be carried out after the emulsified liquid is filled into a packaging container or the like. Alternatively, after the step of cooling, the solidified emulsified liquid may be cut and filled into a packaging container or the like.

The present invention also relates to a method for improving the heat meltability of a cheese-like food comprising an edible fat or oil and water, wherein the cheese-like food comprises 2 to 30% by mass of an acetylated oxidized starch. The cheese-like food preferably comprises 10 to 35% by mass of the edible fat or oil and 30 to 65% by mass of water. Further, the solid fat content in the edible fat or oil at 10° C. is preferably 20 to 95%. In one embodiment of the present invention, the solid fat content in the edible fat or oil at 10° C. is preferably 20 to 75%.

### EXAMPLES

Hereinafter, the present invention will be more specifically described by way of working examples and comparative examples, but the present invention is not limited to the below-described working examples.

### Raw Materials

The below-described materials were used for preparing a cheese-like food.

### Starch

Acetylated oxidized starch (JELCALL SP-2, raw material starch: tapioca starch, manufactured by J-OIL MILLS, INC.)

Oxidized starch (JELCALL SP-3, raw material starch: tapioca starch, manufactured by J-OIL MILLS, INC.)

Acid-treated starch (product prepared in-house according to “Method for producing acid-treated starch” described later)

Acetylated starch (ACTBODY EAT-2, raw material starch: tapioca starch, manufactured by J-OIL MILLS, INC.)

Starch sodium octenyl succinate (N-CREAMER-46, manufactured by Ingredion)

### Raw Fat or Oil

Palm kernel oil (manufactured by J-OIL MILLS, INC.)

Palm oil (manufactured by J-OIL MILLS, INC.)

Rapeseed oil (manufactured by J-OIL MILLS, INC.)

Coconut oil (manufactured by J-OIL MILLS, INC.)

### Soy Milk

Pure soy milk (Oishii-Muchousei-Tounyuu (delicious pure soy milk), water content: 90% by mass, manufactured by Kikkoman Corporation)

### Method for Producing Acid-Treated Starch

To 320 parts by mass of an aqueous dispersion containing 40% by mass of waxy corn starch (manufactured by J-OIL MILLS, INC.), 80 parts by mass of 6% by mass hydrochloric acid was added, and the mixture was stirred at 40° C. for 24 hours to carry out the acid treatment. After the acid treatment, neutralization was carried out using slaked lime so that the pH became 5. After that, washing and drying were carried out, thereby obtaining an acid-treated starch.

### Commercially-Available Cheese

For comparison with cheese-like foods, the below-described commercially-available cheeses were used.

Cheese 1 (Meiji Tokachi Sliced Cheese, manufactured by Meiji Co., Ltd.)

Cheese 2 (SNOW BRAND Sliced Cheese, manufactured by Megmilk Snow Brand Co., Ltd.)

Cheese 3 (KRAFT Kireteru (pre-sliced) Cheese, manufactured by Morinaga Milk Industry Co., Ltd.)

Cheese 4 (Kiri Cream Cheese, manufactured by Itoham Foods Inc.)

### Method for Measuring Solid Fat Content

The solid fat content in the edible fat or oil to be used for the cheese-like food was measured according to METHOD I described in AOCS Official Method Cd 16b-93.

### Method for Measuring Slip Melting Point

The slip melting point of the edible fat or oil to be used for the cheese-like food was measured according to 2.2.4.2 Melting Point (Slip Melting Point) in the Standard Methods for the Analysis of Fats, Oils and Related Materials (1996).

### Cheese-Like Food 1

### Method for Preparing Cheese-Like Food

According to the blending ratio described in Tables 1 and 2, raw materials other than an edible fat or oil were put into a tank, and the mixture was stirred with a propeller-type stirrer while being heated to 90° C. to prepare a liquid glue. To the prepared liquid glue, the edible fat or oil heated to 90° C. was added, and the mixture was further stirred for 30 minutes to obtain an emulsified liquid. A plastic container having a capacity of 150 ml was filled with about 90 g of the emulsified liquid, and then a lid was put on the container, which was transferred to a thermostatic bath whose temperature was set at 5° C. and cooled, thereby obtaining a cheese-like food. Note that in Comparative Example 2, no cheese-like food was successfully prepared because the liquid glue had a high viscosity and was not successfully mixed with the edible fat or oil to be emulsified.

TABLE 1
Unit of Raw Materials: % by Mass

| | | Example | Example | Example | Example |
|---|---|---|---|---|---|
| Raw Materials | | 1 | 2 | 3 | 4 |
| Starch | Acetylated | 22 | 17 | 18 | 25 |
| | oxidized starch | | | | |
| | Acid-treated | | 5 | | |
| | starch | | | | |
| | Oxidized starch | | | | |
| | Acetylated | | | | |
| | starch | | | | |
| Water | | 53 | 53 | 50 | 60 |
| Salt | | 2 | 2 | 2 | 2 |
| Edible fat or oil | Palm kernel oil | 23 | 23 | 30 | 13 |
| | Palm oil | | | | |
| | Rapeseed oil | | | | |
| Total | | 100 | 100 | 100 | 100 |
| Solid fat content | 10° C. | 68 | 68 | 68 | 68 |
| in edible fat or | 20° C. | 39 | 39 | 39 | 39 |
| oil (%) | 35° C. | 0 | 0 | 0 | 0 |

| | | | | |
|---|---|---|---|---|
| Slip melting point of edible fat or | 28 | 28 | 28 | 28 |
| oil (° C.) | | | | |

TABLE 2
Unit of Raw Materials: % by Mass

| Raw | | Example | Example | Comparative | Comparative | Comparative |
|---|---|---|---|---|---|---|
| Materials | | 5 | 6 | Example 1 | Example 2 | Example 3 |
| Starch | Acetylated | 22 | 22 | | | |
| | oxidized | | | | | |
| | starch | | | | | |
| | Acid-treated | | | | | 22 |
| | starch | | | | | |
| | Oxidized | | | 22 | | |
| | starch | | | | | |
| | Acetylated | | | | 22 | |
| | starch | | | | | |
| Water | | 53 | 53 | 53 | 53 | 53 |
| Salt | | 2 | 2 | 2 | 2 | 2 |
| Edible fat | Palm kernel | | 11.5 | 23 | 23 | 23 |
| or oil | oil | | | | | |
| | Palm oil | 23 | | | | |
| | Rapeseed | | 11.5 | | | |
| | oil | | | | | |
| Total | | 100 | 100 | 100 | 100 | 100 |
| Solid fat | 10° C. | 50 | 27 | 68 | 68 | 68 |
| content in | 20° C. | 24 | 9 | 39 | 39 | 39 |
| edible fat | 35° C. | 5 | 0 | 0 | 0 | 0 |
| or oil (%) | | | | | | |

| | | | | | |
|---|---|---|---|---|---|
| Slip melting point of | 32 | 23 | 28 | 28 | 28 |
| edible fat or oil (° C.) | | | | | |

### Method for Evaluating Cheese-Like Food

The cheese-like food 20 days after transfer to the thermostatic bath at 5° C. was used to be evaluated. The evaluation results were as shown in Tables 3-5.

### Measurement of Hardness

### 1. Measurement of Hardness of Cheese-Like Food

The maximum stress was measured under the below-described conditions using a rheometer (NRM-2002J, manufactured by Fudo Kogyo Co., Ltd.). The measurement was carried out 3 times, and the average value was regarded as the hardness.

### Measurement Conditions

Sample: material obtained by shaving off the surface of the cheese-like food several millimeters to be flattened

Plunger: cylindrical shape having a diameter of 5 mm

Stage lifting speed: 6 cm/min

Measurement time: 10 seconds from when the plunger came into contact with the sample

### 2. Measurement of Hardness of Commercially-Available Cheese

The cheese-like food was changed to the commercially-available cheese, and the hardness thereof was measured in the same manner as that in “1. Measurement of hardness of cheese-like food”, except that the surface of the sample was not shaved off. Regarding Cheese 1 and Cheese 2, 15 slices of cheese with films being peeled off were stacked to be used as the sample.

### Measurement of Heat Meltability

Each of the materials except Cheese 1 and Cheese 2 was cut into a cube (20 mm×20 mm×20 mm) to be used as a measurement sample. Regarding Cheese 1 and Cheese 2, 15 slices of cheese with films being peeled off were stacked, which was then cut into a cube (20 mm×20 mm×20 mm) to be used as a measurement sample.

Each measurement sample placed on aluminum foil was put into an oven whose temperature was set at 200° C. After a lapse of 10 minutes after the sample was put into the oven, it was taken out from the oven, and the measurement of the height of the measurement sample and observation of conditions of the measurement sample were carried out.

### Sensory Evaluation

Five expert panelists ate each cheese-like food at 5° C. directly (before heating) and also ate each cheese-like food which was heated under the same conditions as those in the measurement of heat meltability and then left at room temperature for 5 minutes (after heating), and made evaluations based on the below-described evaluation criteria after discussion. As a control sample, Cheese 1 was used.

### Evaluation Criteria

3: having a texture very close to that of the control

2: having a texture close to that of the control

1: having a texture slightly close to that of the control

0: having a texture different from that of the control

TABLE 3
Evaluation Results

| Evaluation Items | | Example 1 | Example 2 | Example 3 | Example 4 |
|---|---|---|---|---|---|
| Hardness (gf) | | 565 | 410 | 437 | 558 |
| Heat meltability | | 5 | 3 | 3 | 5 |
| (mm) | | | | | |
| Before | Sensory | 2 | 3 | 3 | 2 |
| heating | Evaluation | | | | |
| | Conditions | Hardness | Having | Having | Having |
| | | and | hardness | hardness | hardness |
| | | viscosity | and viscosity | and | and viscosity |
| | | inherent to | inherent to | viscosity | inherent to |
| | | cheese are | cheese and | inherent to | cheese, but |
| | | felt | also having | cheese and | rich feeling |
| | | | rich feeling | also having | is slightly |
| | | | | rich feeling | weak |
| After | Sensory | 2 | 3 | 2 | 2 |
| heating | Evaluation | | | | |
| | Conditions | Viscosity | Viscosity | Viscosity | Viscosity |
| | | inherent to | inherent to | inherent to | inherent to |
| | | cheese is | cheese is felt | cheese is | cheese is |
| | | felt | and having | slightly felt | felt |
| | | | rich feeling | and having | |
| | | | | rich feeling | |

TABLE 4
Evaluation Results

| | | | | Com- | Com- |
|---|---|---|---|---|---|
| | | | | parative | parative |
| Evaluation Items | | Example 5 | Example 6 | Example 1 | Example 3 |
| Hardness (gf) | | 502 | 426 | 616 | 1164 |
| Heat meltability (mm) | | 4 | 5 | 19 | 1 |
| Before | Sensory | 2 | 2 | 1 | 0 |
| heating | Evaluation | | | | |
| | Conditions | Hardness | Hardness | Powdery, | Hard and |
| | | and | and viscosity | and | brittle, and |
| | | viscosity | inherent to | viscosity | not like |
| | | inherent to | cheese are | inherent to | cheese |
| | | cheese are | felt | cheese is | |
| | | felt | | weak | |
| After | Sensory | 3 | 2 | 0 | 0 |
| heating | Evaluation | | | | |
| | Conditions | Viscosity | Having | Viscosity | Became |
| | | inherent to | viscosity | inherent to | liquid and |
| | | cheese is | inherent to | cheese is | not like |
| | | felt and | cheese | not felt | cheese |
| | | having rich | | | |
| | | feeling | | | |

TABLE 5
Evaluation Results

| Evaluation Items | Cheese 1 | Cheese 2 | Cheese 3 | Cheese 4 |
|---|---|---|---|---|
| Hardness (gf) | 473 | 536 | 815 | 122 |
| Heat meltability | 4 | 10 | Unmeasured | Unmeasured |
| (mm) | | | | |

All the cheese-like foods of the Examples had a hardness equivalent to those of the commercially-available cheeses. When eating before heating, viscosity and hardness inherent to cheese were felt in the case of the cheese-like foods containing the acetylated oxidized starch. The cheese-like foods containing less than 22% by mass of the acetylated oxidized starch and the cheese-like food containing the acetylated oxidized starch and the acid-treated starch had a texture particularly close to that of the control cheese. According to the results of evaluating heat meltability, all the cheese-like foods containing the acetylated oxidized starch had a heat meltability higher than that of the cheese-like food containing the oxidized starch and equivalent to or higher than those of the commercially-available cheeses. The cheese-like food containing the acetylated oxidized starch and the acid-treated starch and the cheese-like food in which palm oil was used as the edible fat or oil particularly had a high heat meltability, and even after heating, a texture close to that of the control cheese was felt, and rich feeling was also felt.

### Cheese-Like Food 2

According to the blending ratio described in Table 6, a cheese-like food was prepared in a manner similar to that in Example 1, except that water was changed to pure soy milk. The hardness and heat meltability of the prepared cheese-like food were evaluated using the same methods as those of Example 1. The results are shown in Table 6.

TABLE 6
Unit of Raw Materials: % by Mass

| | |
|---|---|
| Raw Materials | Example 7 |

| Starch | Acetylated oxidized starch | 22 |
|---|---|---|
| Pure soy milk | | 53 |
| Salt | | 2 |
| Edible fat or oil | Palm oil | 23 |

| Total | | 100 |
|---|---|---|
| Solid fat content in edible fat or oil (%) | 10° C. | 50 |
| | 20° C. | 24 |
| | 35° C. | 5 |

| | |
|---|---|
| Slip melting point of edible fat or oil (° C.) | 32 |
| Content of water in cheese-like food (% by mass) | 48 |
| Hardness (gf) | 548 |
| Heat meltability (mm) | 4 |

The cheese-like food in which pure soy milk was used instead of water also had a hardness equivalent to those of the commercially-available chesses and had a high heat meltability. When eating it before and after the measurement of heat meltability, viscosity and hardness inherent to cheese were felt in both the cases.

### Cheese-Like Food 3

According to the blending ratio described in Table 7, a cheese-like food was prepared in a manner similar to that in Example 1. Using the same methods as those of Example 1, the hardness and heat meltability of the prepared cheese-like food were evaluated and sensory evaluation thereof before and after heating was carried out. The results are shown in Table 7.

TABLE 7
Unit of Raw Materials: % by Mass

| | | |
|---|---|---|
| Raw Materials | Example 8 | Example 9 |

| Starch | Acetylated oxidized starch | 20 | 18 |
|---|---|---|---|
| | Starch sodium octenyl succinate | | 2 |
| Water | | 42 | 42 |
| Salt | | 2 | 2 |
| Edible fat or oil | Coconut oil | 36 | 36 |

| Total | | 100 | 100 |
|---|---|---|---|
| Solid fat content in edible fat or oil | 10° C. | 85 | 85 |
| (%) | 20° C. | 35 | 35 |
| | 35° C. | 0 | 0 |

| Slip melting point of edible fat or oil (° C.) | | 25 | 25 |
|---|---|---|---|
| Hardness (gf) | | 480 | 614 |
| Heat meltability (mm) | | 3 | 3 |
| Before heating | Sensory evaluation | 2 | 2 |
| | Conditions | Hardness and | Having hardness |
| | | viscosity | and viscosity |
| | | inherent to | inherent to |
| | | cheese are felt | cheese and also |
| | | | having rich |
| | | | feeling |
| After heating | Sensory evaluation | 2 | 2 |
| | Conditions | Viscosity | Viscosity |
| | | inherent to | inherent to |
| | | cheese is felt | cheese is felt |

The cheese-like foods in which coconut oil was used as the edible fat or oil also had a hardness equivalent to those of the commercially-available chesses and had a high heat meltability. In particular, the cheese-like food in which the acetylated oxidized starch and starch sodium octenyl succinate were used in combination had a texture closer to the control cheese when eating without heating and rich feeling was also felt.

### Cheese-Like Food 4

According to the blending ratio described in Table 8, a cheese-like food was prepared in a manner similar to that in Example 1. Using the same methods as those of Example 1, the hardness and heat meltability of the prepared cheese-like food were evaluated and sensory evaluation thereof before and after heating was carried out. The results are shown in Table 8.

TABLE 8
Unit of Raw Materials: % by Mass

| | | | |
|---|---|---|---|
| Raw Materials | Example 10 | Example 11 | Example 12 |

| Starch | Acetylated oxidized | 4 | 6 | 6 |
|---|---|---|---|---|
| | starch | | | |
| | Acid-treated starch | 16 | 16 | 14 |
| | Starch sodium octenyl | 2 | | 2 |
| | succinate | | | |
| Water | | 50 | 50 | 50 |
| Salt | | 2 | 2 | 2 |
| Edible fat or oil | Palm kernel oil | 26 | 26 | 26 |

| Total | | 100 | 100 | 100 |
|---|---|---|---|---|
| Solid fat content in edible | 10° C. | 68 | 68 | 68 |
| fat or oil (%) | 20° C. | 39 | 39 | 39 |
| | 35° C. | 0 | 0 | 0 |

| Slip melting point of edible fat or oil (° C.) | | 28 | 28 | 28 |
|---|---|---|---|---|
| Hardness (gf) | | 463 | 535 | 530 |
| Heat meltability (mm) | | 3 | 2 | 3 |
| Before heating | Sensory evaluation | 2 | 2 | 3 |
| | Conditions | Hardness and | Hardness | Having |
| | | viscosity | and viscosity | hardness |
| | | inherent to | inherent to | and viscosity |
| | | cheese are | cheese are | inherent to |
| | | felt | felt | cheese and |
| | | | | also having |
| | | | | rich feeling |
| After heating | Sensory evaluation | 2 | 2 | 2 |
| | Conditions | Viscosity | Viscosity | Viscosity |
| | | inherent to | inherent to | inherent to |
| | | cheese is felt | cheese is felt | cheese is felt |

The cheese-like foods containing 4 to 6% by mass of the acetylated oxidized starch and 14 to 16% by mass of the acid-treated starch had a hardness equivalent to those of the commercially-available chesses and had a high heat meltability. In both the cases of eating before heating and eating after heating, viscosity inherent to cheese was felt.

### Food Comprising Cheese-Like Food

15 g of the cheese-like food of Example 2 twenty days after transfer to the thermostatic bath at 5° C. that was cut into shreds was placed on all over a slice of bread (Choujuku 5 Slices, manufactured by Pasco Shikishima Corporation). It was toasted for 4 minutes using a toaster oven whose temperature was set at 200° C. to prepare a toast.

When eating the bread on which the cheese-like food was placed, a texture inherent to cheese and a texture of the bread were combined to provide a satisfactory texture. When eating the toast obtained by toasting with the toaster oven, a texture inherent to cheese provided by the heat-melted cheese-like food was combined with the toasted bread to provide the toast having a satisfactory texture.

Many other benefits will no doubt become apparent from future application and development of this technology.

All patents, applications, standards, and articles noted herein are hereby incorporated by reference in their entirety.

The present subject matter includes all operable combinations of features and aspects described herein. Thus, for example if one feature is described in association with an embodiment and another feature is described in association with another embodiment, it will be understood that the present subject matter includes embodiments having a combination of these features.

As described hereinabove, the present subject matter solves many problems associated with previous strategies, systems and/or devices. However, it will be appreciated that various changes in the details, materials and arrangements of components, which have been herein described and illustrated in order to explain the nature of the present subject matter, may be made by those skilled in the art without departing from the principle and scope of the claimed subject matter, as expressed in the appended claims.

What is claimed is:

1. A cheese-like food comprising 2 to 30% by mass of an acetylated oxidized starch, 10 to 35% by mass of an edible fat or oil and 30 to 65% by mass of water, wherein the solid fat content in the edible fat or oil at 10° C. is 20 to 95%.

2. The cheese-like food according to claim 1, comprising 1 to 19% by mass of an acid-treated starch.

3. The cheese-like food according to claim 1, wherein the content of the acetylated oxidized starch is 8 to 250 parts by mass relative to 100 parts by mass of the content of the edible fat or oil in the cheese-like food.

4. The cheese-like food according to claim 1, wherein the solid fat content in the edible fat or oil at 35° C. is 0 to 10%.

5. The cheese-like food according to claim 1, which is to be heated.

6. A food comprising the cheese-like food according to claim 1.

7. A method for producing a cheese-like food, the method comprising:
preparing a mixture comprising water, an acetylated oxidized starch and an edible fat or oil;
heating and stirring the mixture to obtain an emulsified liquid; and
cooling the emulsified liquid,
wherein the cheese-like food comprises 2 to 30% by mass of the acetylated oxidized starch, 10 to 35% by mass of the edible fat or oil and 30 to 65% by mass of water, and wherein the solid fat content in the edible fat or oil at 10° C. is 20 to 95%.

8. A method for improving the heat meltability of a cheese-like food comprising an edible fat or oil and water, wherein the cheese-like food comprises 2 to 30% by mass of an acetylated oxidized starch.

9. The method according to claim 8, wherein the cheese-like food comprises 10 to 35% by mass of the edible fat or oil and 30 to 65% by mass of water.

10. The method according to claim 8, wherein the solid fat content in the edible fat or oil at 10° C. is 20 to 95%.
